(19) United States
(12) Patent Application Publication
(10) Pub. No.: US 2004/0210929 A1
(43) Pub. Date: Oct. 21, 2004

(54) Methods and apparatus forscheduling broadcast commercial videotapes

(76) Inventors: Srinivas Bollapragada, Niskayuna, NY (US); Suman Mallik, Champaign, IL (US)

Correspondence Address: GENERAL ELECTRIC COMPANY (PCPI), C/O FLETCHER YODER, P. O. BOX 692289, HOUSTON, TX, 77269-2289, US

(21) Appl. No.: 10/418,494

(22) Filed: Apr. 18, 2003

(51) Int. Cl. H04N 7/025; H04N 7/10

(52) U.S. Cl. 725/32

(57) ABSTRACT

A method for scheduling broadcast commercials includes automatically scheduling a commercial to air a plurality of times on a plurality of shows within a specified time period.

### BACKGROUND OF THE INVENTION

This invention relates generally to commercials and, more specifically, to methods and apparatus for automatically scheduling broadcast commercials.

Television (TV) networks broadcast a wide variety of programming often directed to a specific market, for example, talk shows, sports, game shows, and other entertainment shows. Additionally, prime time entertainment shows typically have wide appeal. Networks selling advertising slots to clients sell commercial space by the show on which a commercial will air. A commercial break includes a plurality of advertising slots wherein commercials can be broadcasted (i.e., aired). During the broadcast season the clients ship videotapes of the commercials to be aired in the slots that they had purchased. Each tape has a single commercial and has a code written on it for identification. These codes are called Industry Standard Commercial Identification (ISCI) codes. The commercials are scheduled by ISCI codes by TV network personnel according to the instructions given by the advertiser.

Whenever a commercial is to be aired multiple times within a specified period (e.g., a month), the advertiser (i.e., a client) typically wants these airings to be as much evenly spaced as possible over that time period. Thus, a client has certain number of advertising slots that it has purchased during a specified time period. It also has a set of commercials to be scheduled in its time slots. The question naturally arises how to schedule the commercials on the available advertising slots such that two airings of the same commercial are as much evenly spaced as possible over the specified time period. To schedule the commercials and meet the above criteria, the network manually examines the criteria and then schedules the commercials to best meet the criteria. Manually scheduling the commercials, for a large quantity of clients can be a cumbersome and time intensive process. Further, manually scheduling the commercials may lead to errors in the schedule.

### BRIEF DESCRIPTION OF THE INVENTION

In one aspect, a method for scheduling broadcast commercials is provided. The method includes automatically scheduling a commercial to air a plurality of times on a plurality of shows within a specified time period.

In another aspect, a computer is programmed to schedule a commercial to air a plurality of times on a plurality of shows within a specified time period.

In yet another aspect, a computer readable medium encoded with a program is provided. The program is configured to instruct a computer to schedule a commercial to air a plurality of times on a plurality of shows within a specified time period.

### BRIEF DESCRIPTION OF THE DRAWINGS

FIG. 1 illustrates a plurality of test problems.

FIG. 2 illustrates a summary of computations performed on the problems illustrated in FIG. 1.

FIG. 3 illustrates computational results for a herein described algorithm and heuristics.

FIG. 4 illustrates a plurality of percentage gaps.

FIG. 5 illustrates computations wherein a Lagrangian heuristic described herein was used to obtain an upper bound.

FIG. 6 illustrates computational results for an ISCI Rotator problem with pre-placements.

### DETAILED DESCRIPTION OF THE INVENTION

Whenever a commercial is to be aired a plurality of times within a specified period, an advertiser typically wants these airings to be as much evenly spaced as possible over that time period. Thus, there are N commercials to be scheduled during a specific time period, out of which n1 of ISCI code 1, n2 are of ISCI code 2, and so on. The objective is to schedule these commercials into N slots such the multiple airings of the same commercials are as much evenly spaced as possible. Mathematically, this is equivalent to the following problem. There are N balls out of which n1 are of color 1, n2 are of color 2, and so on. The goal is to put the N balls into N slots such that balls of any one color are as much evenly spaced as possible. This application presents a mathematical programming based approach for accomplishing this. This problem is called the basic ISCI Rotator problem or, simply, the ISCI problem. For the ease of exposition, this problem is set forth with balls and slots.

Also considered herein is an extension to the basic ISCI Rotator problem described above. The advertisers often have preferences for the advertising slots during a time period. For example, an advertiser might want to air a commercial in a specific time slot. The broadcasting firm will typically entertain such request. The question naturally arises how to accommodate such requests while still maintaining the objective of making the commercials from any one advertiser as much evenly spaced as possible. The herein described framework of analysis admits this extension by assuming that some of the slots have pre-placed balls. Given these pre-placed balls, the objective is to place the remaining balls in the empty slots such that balls of one color are as much evenly spaced as possible in the final arrangement.

In an exemplary embodiment, the herein described methods are computer implemented and, as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein. Additionally, in one embodiment, a computer (not shown) employing the herein described methods includes a digital media device (not shown), for example, a floppy disk drive, CD-ROM drive, DVD drive, magnetic optical disk (MOD) device, or any other digital device including a network connecting device such as an Ethernet device for reading instructions and/or data from a computer-readable medium (not shown), such as a floppy disk, a CD-ROM, a DVD, a MOD or an other digital source such as a network or the Internet, as well as yet to be developed digital means, wherein the computer readable medium is encoded with a computer program configured to instruct the computer to perform at least some of the functions described herein. In another embodiment, the computer executes instructions stored in firmware (not shown).

Consider a set of N balls out of which n₁ are of color 1, n₂ are of color 2, and so on. The goal is to place these N balls into N slots such that the balls of any one color are as much evenly spaced over the slots as possible. As mentioned above, this problem is called the ISCI Rotator problem. The following notation is defined to formulate the model.

j=index on color, j=1, 2, . . . , J

nⱼ=number of balls of color j

N=total number of balls

$$N = total number of balls = {\sum }_{j} {n}_{j} ,$$

also equals the total number of slots

iⱼ=index on balls of color j, iⱼ=1, 2, . . . , nⱼ, ∀ⱼ

k=index on slots, k=1, 2, . . . , N

qⱼ=ideal distance between any two balls of color j=N/nⱼ

Zᵢ_{ⱼ}=slot number of ball i of color j (decision variable)

$${Y}_{{i}_{j} k} = \{ \begin{matrix}1 , & if ball i of color j is assigned to slot k \\ 0 , & otherwise\end{matrix}$$

In addition, the notation └x┘ is used to denote the largest integer less than or equal to x. With the above notation, the decision variables are Zᵢ_{ⱼ}. The basic ISCI Rotator problem is formulated as a non-linear integer program.

Problem P1

$$Minimize {\sum }_{i} {\sum }_{j} \vert {Z}_{{i}_{j}} - {Z}_{i - {1}_{j}} - {q}_{j} \vert \qquad ( 1 )$$

Subject to:

Zᵢ₋₁_{ⱼ}≦Zᵢ_{ⱼ}−1, ∀i,j (2)

$$\begin{matrix}{\sum }_{i , k} {Y}_{{i}_{j} k} = {n}_{j} , ∀ j & ( 3 ) \\ {Z}_{{i}_{j}} = {\sum }_{k} {kY}_{{i}_{j} k} , ∀ i , j & ( 4 ) \\ {\sum }_{i , j} {Y}_{{i}_{j} k} = 1 , ∀ k & ( 5 )\end{matrix}$$

1≦Zᵢ_{ⱼ}≦N, Yᵢ_{ⱼ}ₖ binary (6)

Note that qⱼ is defined to be the ideal distance between any two balls of color j so that the balls of color j are evenly spaced over the slots. This distance need not be an integer. However, the slot numbers (indexed by k) are always integers. The objective is to have the spacing between any two balls of color j to be as close to qⱼ as possible. The quantity |Zᵢ_{ⱼ}−Zᵢ₋₁_{ⱼ}−qⱼ| is the deviation of the distance between the (i−1)^{th} ball and the i^{th} ball of color j from its ideal spacing. The objective function (1) in the above formulation, thus, is the sum of deviations from the ideal spacing for each ball of each color. Constraint (2) ensures an ordered arrangement of the balls. Constraint (3) ensures that all balls are used while (5) ensures that only one ball can be placed in each slot. Note that the integrality of the variables Zᵢ_{ⱼ} is guaranteed through constraint (4), which describes the relationship between the Y and Z variables. The nonlinear problem P1 can be transformed to a linear problem as described below.

Problem P2

$$Minimize {\sum }_{j} {\sum }_{i} ( {X1}_{{i}_{j}} + {X2}_{{i}_{j}} ) \qquad ( 7 )$$

Subject to:

Constraints (2), (3), (4), (5), (6)

X1ᵢ_{ⱼ}≧Zᵢ_{ⱼ}−Zᵢ₋₁_{ⱼ}−qⱼ, ∀i, j (8)

X2ᵢ_{ⱼ}≧−(Zᵢ_{ⱼ}−Zᵢ₋₁_{ⱼ}−qⱼ), ∀i,j (9)

X1ᵢ_{ⱼ}≧0, X2ᵢ_{ⱼ}≧0, ∀i,j (10)

In the above formulation two additional sets of variables X1 and X2 are introduced to accommodate the modulus sign. Constraint (8) and (9) together with the non-negativity constraint (10) imply that only one of X1ᵢ_{ⱼ} and X2ᵢ_{ⱼ} ∀i,j, is positive.

The problem P2 can be solved trivially when nⱼ=n,∀j, i.e. when there is the same number of balls of each color. Consider an arrangement of balls in which the sequence of colors 1, 2, . . . , J are repeated n times. This is an optimal arrangement as it gives rise to an objective function value of zero. In other words, when nⱼ=n,∀j, the optimal arrangement of balls for an N-slot-problem can be obtained by solving a problem with N/n slots (containing one ball of each color) and repeating the arrangement n times. Under such a situation, solving a problem of size N/n is equivalent to solving a problem of size N. However, a generalization of this proof is not possible.

For example, if there is a common factor, α (with α>1), among the nⱼ's, then solving a problem of size N/α is not necessarily equivalent to solving a problem of size N. The proof is by construction. Consider an example with N=14, and with n₁=6, n₂=n₃=4. Here, α=2, q₁=2.33, q₂=q_{3.5}. To show the generalization is not possible, one can show that an optimal arrangement of balls for this problem cannot be obtained by solving a problem with N=7, and n₁=3, n₂=n₃=2. It can be verified (using any commercial Mixed Integer Programming “MIP” solver) that the optimal objective value for the original problem with N=14 is 4.67. Also note that in any feasible solution to this problem, the contribution to objective function of equation (7) from the balls of color 2 and 3 will be at least 1.5 each (since q₂=q₃=3.5, any arrangement of ball of color 2 or color 3 will contribute at least 0.5 ×(4−1)=1.5 to the objective). Thus, in an optimal arrangement, the contribution to objective function from color 1 balls will be at most 1.67. Note that q₁=2.33. This means that contribution to objective function from color 1 balls will be minimum when the spacing between the balls is 2. Thus, there is only 4 possible arrangements of color 1 balls in the slots: (1,3,5,7,9,11), (2,4,6,8,10,12), (3,5,7,9,11,13), and (4,6,8,10,12,14), each of which will give a contribution of 1.67 to the objective function. Therefore, in an optimal solution, one must have one of these 4 arrangements for color 1 balls. Note however, that none of these arrangements can be obtained by juxtaposing optimal solutions for the problem with N=7 twice (as none of the 4 arrangements of color 1 balls are symmetric about the middle). Therefore, it is not possible to find the optimal arrangement of balls for the original problem of size 14 by solving a problem of size 7.

This second result is quite counter-intuitive, given the first result. It is also instructive to discuss the single color sub-problem. This problem is called the single color ISCI problem. In the single color ISCI Rotator problem n balls, all of same color, are to be placed in N slots (with n≦N ) such that the balls are as much evenly spaced over the slots as possible. The formulation for the single color ISCI Rotator problem can be obtained by changing the equality relation in (5) to “less than equals to” in P1, and by dropping the subscript j and the summation over j in (1)-(6). It is interesting to note that solution to the single color ISCI Rotator problem is, in general, not the same as that of maximizing the minimum distance between any two balls. In fact, no simple method to solve the single color ISCI Rotator problem to optimality was found.

In this section an optimal algorithm for the ISCI Rotator problem is described. The algorithm constructs the solution by placing one ball at a time starting with the first slot. Note that a slot can accommodate any one of the available colors. Thus there are a total of N!/(n₁!n₂! . . . n_{J}!) feasible solutions where “n!” represents the factorial of n. Evaluating all of these solutions may be impractical is certain implementations. Therefore, a branch and bound like algorithm is described which prunes a lot of the search space, thereby increasing the speed of the algorithm.

A classical branch-and-bound algorithm for mixed integer-programming problems solves a continuous relaxation of the problem at each node of a search tree. The continuous relaxation formed by relaxing the integrality requirements results in a linear programming problem. It then creates two successor nodes by branching on a variable that has a fractional value in the solution of the relaxation. The relaxation provides two devices for reducing the size of the search tree.

First device, the optimal value of the continuous relaxation is a lower bound on an optimal solution at the problem at that node. There is no point in branching further at the node if this bound is larger than the value of a feasible solution found earlier in the search.

Second device, it may happen that all of the integer variables have integral values in the solution, even though only a few have been fixed to integral values. This yields a feasible solution without going deep into the tree.

A similar branch-and-bound scheme is used in the instant algorithm, taking advantage of the first device noted above to reduce the size of the search tree. At the root node, the color of the ball to be assigned to slot 1 is determined. Since there are J colors, there are at most J branches emanating from this node, one for each color ball. At level 2, the color of the ball to be placed in slot 2 is determined, given that slot 1 is already filled. Thus the depth of the complete tree to be evaluated is N. Visiting all nodes in the tree is equivalent to evaluating all the feasible solutions. However, if one can compute a good lower bound on the solution at each node, the search space could be pruned. Now described is the procedure for obtaining the lower bound.

Let S=(s₁,s₂, . . . , s_{N})be the vector of assignments in any solution to the problem. Thus, sₖ=j implies that a ball of color j is placed in slot k. At level i in the search tree, all sₖ for which k<i are fixed and a decision on sᵢ has to be made. To prune the search tree, a lower bound on the objective function value obtained after placing the remaining balls is needed. Let M=(m₁m₂, . . . , m_{J}) denote the vector of yet unassigned balls. Thus, mⱼ=λ implies that there are λ number of color j balls yet to be assigned to slots. To compute the lower bound, the best possible placement for the remaining balls of each color is assumed. This is accomplished by placing the remaining balls of each color assuming that all remaining slots are available to them. The procedure for obtaining the lower bound is as follows.

```
      Procedure LowerBound (i)
Let LB be the lower bound.
Set LB [symbol] Objective function contribution from the first i-1 slots
For each colorj
  Place the remaining mⱼ balls in the remaining N-i open slots
    to achieve a spacing as close to qⱼ as possible between the
```

balls

```
  Let OBj be the contribution to objective function from the mⱼ balls
  Set LB [symbol] LB + OBj
End For Loop
Return LB
```

End Procedure

The search algorithm does a depth first search of the tree. At each node it compares the lower bound with the objective of the best solution obtained thus far. The portion of the search tree beneath the node is pruned if the lower bound is greater than the current best objective value. The depth first search is described in detail below in the recursive procedure titled “Branch (k)” where k denotes the node level in the tree. To better prune the search tree, a good feasible solution using one of the heuristics described in section 5 is first obtained and used as the current best solution to start with.

### The Algorithm

Let B denote the current best solution and set B to the solution obtained using one of the heuristics described in section 5.

Set sₖ=0k=1, . . . , N

```
Call Branch (0)
Print the optimal solution, B
Procedure Branch (k)
  If k = N {
    If objective value of S is less than that of B, then set B = S
    Return
    }
  Else {
    For each j where mⱼ >0 {
    Set sₖ = j
    If LowerBound(k+1) is less than objective value of B, then Call
    Branch(k+1)
    }
  }
End Procedure
```

### Approximate Solutions for P2 (Section 5)

Several approximate solutions are described in this Section. Three heuristics are presented in Section 5.1. A Lagrange relaxation scheme for P2 is described in Section 5.2. Various solutions are described in Section 6.

### Heuristic Solutions for P2 (Section 5.1)

### Heuristic 1

For all balls of any specific color j:

1. Let αⱼ=qⱼ−└qⱼ┘. If αⱼ≦0.5 then Spacingⱼ=└qⱼ┘, else Spacingⱼ=└qⱼ┘+1.

2. Find the first empty slot (say slot z), and place the ball of color j. Update the number of balls left for color j.

3. Update z: z=z+Spacingⱼ. If slot z is empty, place another ball of color j in slot z. Otherwise, look for the empty slot closest to z in the following order.

If αⱼ≦0.5, search for an empty slot in the following order: z+1, z−1, z+2, z−2, and so on

If αⱼ≧0.5, search for an empty slot in the following order: z−1, z+1, z−2, z+2, and so on

Designate this empty slot as z. Place another color j ball at this empty slot.

4. Update the number of balls left for color j.

5. If number of color j balls left>0, Go to Step 3.

Repeat for balls of all colors.

Heuristic 1 attempts to minimize the objective function equation (1) in a myopic manner for each color j. The choice of spacing in step 1 and the search order in step 3 of the heuristic ensure that the contribution added to (1) for the current ball is minimum. The same logic is repeated for each ball of each color.

### Heuristic 2: Greedy Heuristic

Under a greedy heuristic the slots are filled sequentially. For each slot, a ball color (from the pool of available balls of different colors) is chosen that gives the least contribution to the objective function defined by equation (1). The specific steps are described below.

1. Place a ball of color 1 (or of any other color) in slot 1.

2. Update the number of balls left for the current color

3. Proceed to the next slot. Among the available balls, select that color which gives minimum contribution to objective function defined by equation (7).

4. Stop if this is the last slot, else go to Step 2.

### Heuristic 3

This heuristic generates a good feasible solution for the single-color ISCI Rotator problem first. The single color ISCI Rotator problem was defined above. Before describing the heuristic 3 the following terminologies are defined. A solution of the single color ISCI Rotator problem is represented by a 0-1 vector V=(v₁, v₂, . . . , v_{N}) with vₖ=1, if a ball is placed in slot k, k=1, 2, . . . , N; and, vₖ=0 otherwise. Note that V is of dimension N, the number of slots. For example, consider N=6, and n=2. One possible solution for this single color ISCI Rotator problem is: V=(1, 0, 0, 1, 0, 0). This means that one ball is placed in slot 1 while another ball is placed in slot 4. A shift operation of order k is defined on the vector V as S^{k} (V), resulting in another vector W=(w₁, w₂, . . . , w_{N}) such that

$${w}_{j} = \{ \begin{matrix}\begin{matrix}{v}_{j - k} , & for j > k \\ {v}_{N - k + j} , & for j \leq k\end{matrix} , & ∀ j = 1 , 2 , … , N .\end{matrix}$$

Thus, in the example just described, S²(V)=(0, 0, 1, 0, 0, 1). A conflict is defined as existing between two 0-1 vectors, V and W, of dimension N, if wⱼ+vⱼ>1, for any j=1,2, . . . , N.

The total conflict between the two vectors, V and W, is defined to be

$${\sum }_{j ∈ Ω} {w}_{j} + {v}_{j} ,$$

where Ω={j|wⱼ+vⱼ>1}.

These definitions can be generalized to any number of vectors. The steps of the heuristic are summarized below.

1. Solve the single color ISCI Rotator problem separately for each color j using the following heuristic:

Let αⱼ=qⱼ−└qⱼ┘. If αⱼ≦0.5 then Spacingⱼ=└qⱼ┘, else Spacingⱼ=└qⱼ┘+1

Place the balls of color j as per Spacingⱼ, beginning with slot 1

Let this solution be denoted by a N-dimensional 0-1 vector Vⱼ

There now are J0-1 vectors denoted by V₁, . . . , V_{J}.

2. Fix vector V1. Apply the shifts 1, 2, . . . └q₂┘+1 successively to vector V2. For each of these shift operations applied on V2, apply the shifts 1, 2, . . . └q₃┘+1 successively to vector V3. For each of these shift operations applied on V3, apply the shifts 1, 2, . . . └q₄┘+1 successively to vector V4, and so on until the shifts 1, 2, . . . └q_{J}┘+1 are applied to VJ. Select the combination of shifts that result in minimum total conflict. Apply this combination of shift operations to vectors V2, . . . VJ respectively.

3. Stop if the total conflict is zero. Else, go to Step 5.

4. At the beginning of this step there will be some slots with only one ball, some slots with more than one ball, and some empty slots. Let A be the set of slots with only one ball and let B be the set of slots with more than one ball or the empty slots. Note that A can be an empty set.

5. Fix the solutions for slots in set A. Solve problem P2 for slots in set B using the algorithm described above the section titled “The Algorithm”.

### Lagrangian Relaxation of P2 (Section 5.2)

A lower bound is computed for P2 via a Lagrangian relaxation. By dualizing constraint (5) using multipliers λₖ, one obtains the Lagrangian problem:

$$\begin{matrix}Problem LR \\ v ( LR ) = Min {\sum }_{j} [ {\sum }_{i} ( {X1}_{{i}_{j}} + {X2}_{{i}_{j}} ) + {\sum }_{k} {\sum }_{i} {λ}_{k} {Y}_{{i}_{j} k} ] + {\sum }_{k} {λ}_{k}\end{matrix}$$

Subject to (2), (3), (4), (6), (8), (9), and (10).

There are no constraints in LR linking the colors. Thus, LR decomposes into J independent sub-problems LRⱼ:

$$\begin{matrix}Problem {LR}_{j} \\ v ( {LR}_{j} ) = Min {\sum }_{i} ( {X1}_{{i}_{j}} + {X2}_{{i}_{j}} ) + {\sum }_{k} {\sum }_{i} {λ}_{k} {Y}_{{i}_{j} k}\end{matrix}$$

Subject to (2), (3), (4), (6), (8), (9), and (10).

A GAMS/CPLEX solver was used to carry out the optimization LRj. Finally, the following was calculated:

$$v ( LR ) = {\sum }_{j = 1}^{J} v ( {LR}_{j} ) + {\sum }_{k} {λ}_{k} .$$

The value of the Lagrangian dual (LD) is v(LD)=Max{v(LR)|λ≢0}. Note that the following relationship holds: v(P2)≧v(LD)≧v(P2), where P2 is the linear programming relaxation of P2. P2 does not have the integrality property. Optimum values of the Lagrange multipliers were found using a subgradient method (as taught by Fisher M. L. 1981. Lagrangian Relaxations for Integer Programming Problems. Management Science. 27(1), 1-18). At each iteration, a new lower bound is obtained by solving the Largangian problem to optimality and Lagrange multipliers are updated. The initial values of the Lagrange multipliers are set to the shadow prices of constraint (5) in \overline{P2}. Define

$${γ}_{k} = 1 - {\sum }_{i , j} {Y}_{{i}_{j} k} , ∀ k ,$$

where γₖ is the subgradient of the Lagrangian dual at λ The new multipliers are obtained as λ_{new}=λ_{old}+ργₖ, where ρ=δ(Z*−v(LR))/∥γ∥², Z* is the incumbent upper bound value, ∥.∥ denotes the Euclidean norm, and δ is a scalar constant with 0<δ≦2.

The solutions of the single color subproblems, when combined, yield an arrangement of balls in the slots. This arrangement is not feasible in general because it may contain slots with multiple balls and empty slots. But a developed Lagrangian heuristic makes this infeasible problem feasible. The heuristic involves two steps: first, removing one or more balls from the slots with multiple balls so that only one ball is left in each of those slots; and second, placing these balls in the available empty slots. The following steps accomplish these objectives.

For each color j, define

$${S}_{j} = \{ \begin{matrix}⌊ {q}_{j} ⌋ , & if {q}_{j} - ⌊ {q}_{j} ⌋ \leq 0.5 \\ ⌊ {q}_{j} ⌋ + 1 , & if {q}_{j} - ⌊ {q}_{j} ⌋ > 0.5\end{matrix} . \qquad ( 11 )$$

With the current arrangement of balls of all colors, evaluate

$$\begin{matrix}{θ}_{j} = [ {\sum }_{i} \vert {z}_{{i}_{j}} - {z}_{i - 1 {,}_{j}} - {q}_{j} \vert ] - ( {n}_{j} - 1 ) * \vert {q}_{j} - {S}_{j} \vert & ∀ j .\end{matrix} \qquad ( 12 )$$

Leave the slots with only one ball undisturbed. Begin with the color with highest θⱼ. Remove this color from all slots with multiple balls. Next, select the color with next-highest value of θⱼ. Remove this color from all slots with multiple balls. Repeat this step till there is only one ball left in each of the slots that contained multiple balls. If this results in the same value of θⱼ for multiple colors, then select a color with lowest nⱼ first.

At the beginning of this step there will be some slots with only one ball and some empty slots. There will also be some balls available for placement in the empty slots. Use exhaustive enumeration to place the unassigned balls in the available empty slot, leaving the assigned slots undisturbed, so that the objective function in equation (1) is minimized.

The above heuristic attempts to make the Lagrangian solution feasible. qⱼ is defined to be the ideal distance between the balls of color j. Note that, by definition, qⱼ can be a fraction. Given qⱼ, Sⱼ in (11) defines the best attainable spacing for color j balls. Thus, the quantity (nⱼ−1)*|qⱼ−Sⱼ| denotes the minimum contribution to objective function that color j will make. Thus, θⱼ in (12) is a measure of how close the current solution of color j balls is to the best possible solution. The objective is to leave the colors with lowest values of θⱼ undisturbed. In the next stage the method described uses exhaustive enumeration to obtain the best possible arrangement of balls. Computation at this stage is not a challenge as the size of the problem is reduced. Note this heuristic solution is an upper bound to problem P2 while v(LD) is a lower bound to problem P2.

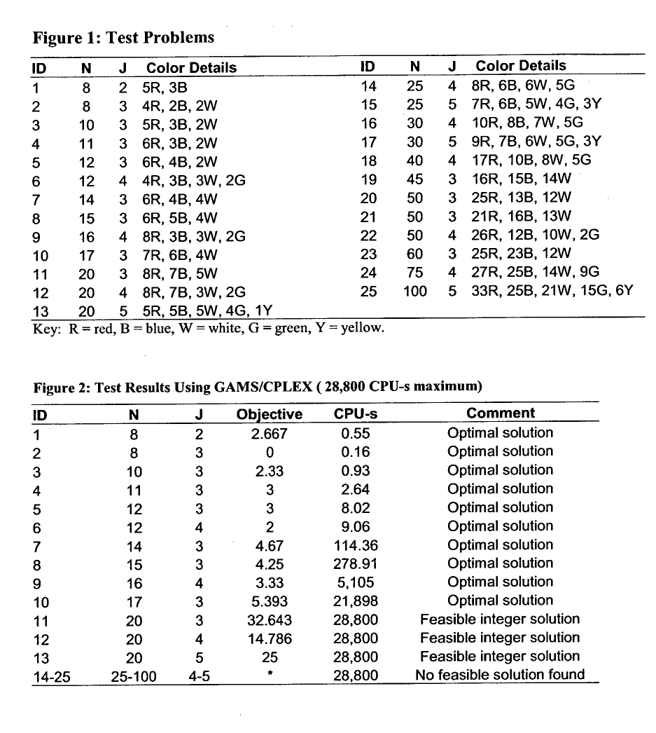

25 randomly generated test problems were generated to test the effectiveness of the heuristics and the algorithm for optimal solution presented herein. All computations were run on a personal computer with Intel Pentium III processor at 850 MHz. FIG. 1 describes the test problems. The total number of slots (N) and the number of colors (J) against each problem were specified. The column labeled “Color Details” in FIG. 1 describes the numbers of balls of each color. Thus, problem 1 has 8 balls out of which 5 are red and 3 are blue.

The formulation P2 was modeled using GAMS and the test problems were solved using GAMS/CPLEX solver (CPLEX version 7.0). The “special order sets of type one (SOS1)” feature of GAMS was used to model the Yᵢ_{ⱼ}ₖ variables. All computations were terminated after 8 hours (28,800 seconds) of CPU time usage. Optimal solutions were obtained for problems 1-10. Feasible integer solutions were obtained for problems 11-13, while no feasible solutions was found for the rest of the problems within 8 hours of CPU usage. FIG. 2 gives the summary of the computations. As expected, the computation time increases with N, the number of slots.

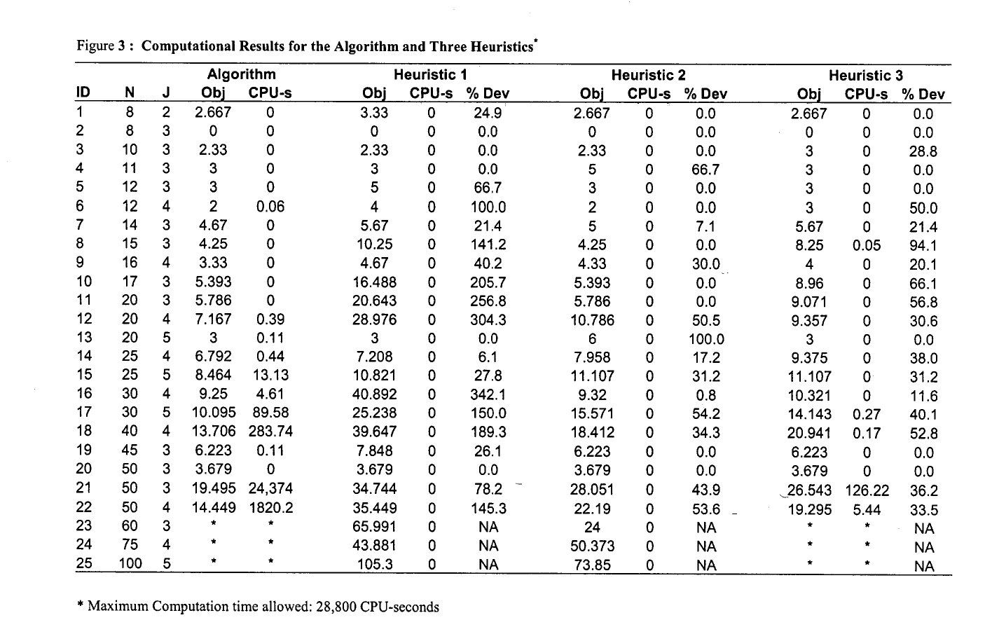

The optimal algorithm as described above and the three heuristics described in Section 5.1 were implemented in the Java programming language. The computational results for the algorithm and the heuristics are described in FIG. 3. The performances of the three heuristics are compared by tabulating the percentage deviation of each heuristic from the optimal solution. FIG. 3 also compares the respective run times.

Optimal solutions were obtainable for 22 of the 25 test problems using the algorithm described in the section titled “The Algorithm” within the 8 hours of allowed CPU time usage. Accordingly, one can solve up to a maximum of 50-slot problem within that time. The GAMS/CPLEX solver could solve only a 17-slot problem to optimality within that time. Using FIGS. 2 and 3 one can compare the computation times of the algorithm with those of GAMS/CPLEX solver for those problems for which optimal solutions could be found by both methods. The algorithm runs substantially faster than CPLEX for these test problems.

By comparing the percentage deviations from the optimal solution, one can see that the greedy heuristic (Heuristic 2) performs substantially better that the other two heuristics for majority of the test problems. In fact, the greedy heuristics performs better than (or as good as) Heuristic 1 in 20 of the 25 test problems. Similarly, the greedy heuristic performs better than Heuristic 3 in 15 of the 22 test problems. The greedy heuristic is within 1% of the optimal solution in 11 of the 22 test problems. The elegance of this heuristic lies in its simplicity and easy computability. However, there are cases where the other two heuristics performed better than the greedy heuristic. Heuristic 3 solutions were obtainable for problems 23-25 within 8 hours of CPU usage time. The difficulty arises because of the large size of the problems. Having some balls fixed at specified slots does reduce the search space. However, it still was not enough to get a solution within the allowable CPU usage time.

To understand the circumstances under which the percentage deviations from the optimal solution increase for the heuristics is desirable. The greedy heuristic was of particular interest. From computational experiences it appears that the structure of the problem plays a key role in determining the accuracy of the heuristics. With the exception of problem 13, the greedy heuristic performs well when the number of slots is completely divisible by the number of balls (i.e. when qⱼ's are integers). Heuristic 1 also performs relatively well when qⱼ's are integers. The computation time for the algorithm, expectedly, increases with N, the total number of slots. Solutions for N=50, but not for N=60 were obtainable within 8 hours of CPU time. In addition, the computation time also depends on the number of colors and qⱼ's.

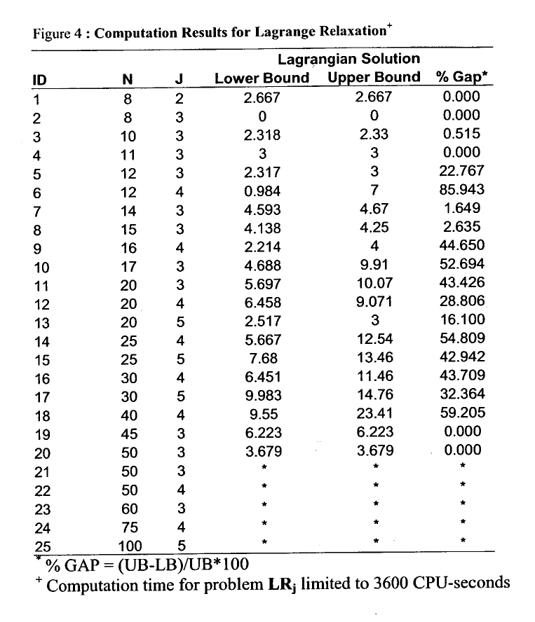

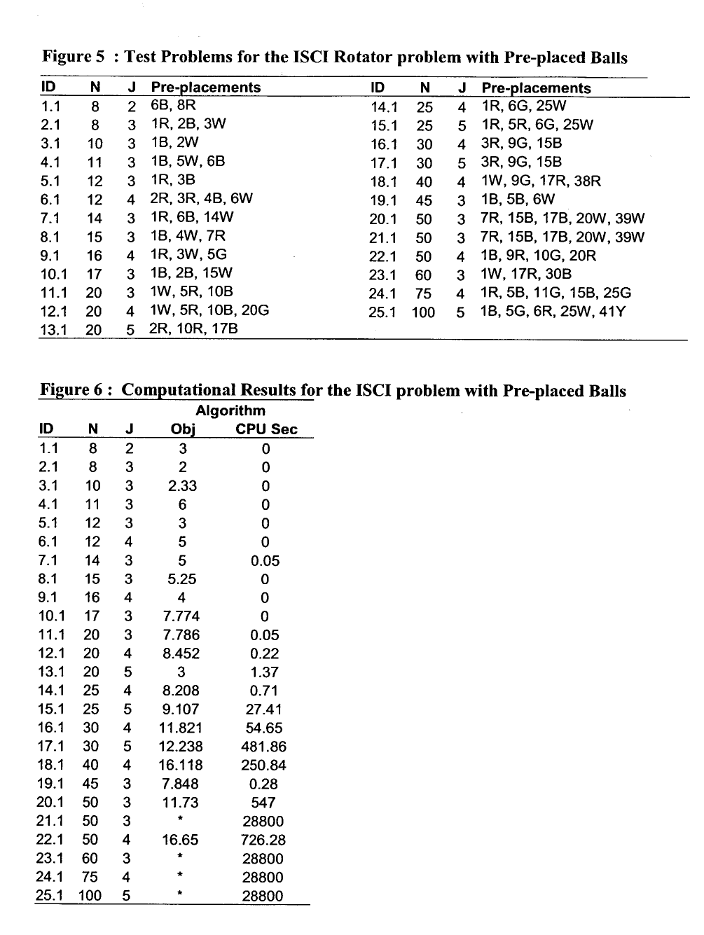

Next presented are the computational results from the Lagrange relaxation scheme. All computations were carried out using the same personal computer described earlier. The LRⱼ subproblems were solved using the GAMS/CPLEX solver. A CPU usage limit was established of one hour for any subproblem LRⱼ. If a subproblem could not be solved within this time, all computations for the corresponding problem were terminated. Lower bounds for the problem P2 was calculated as described in Section 5.2. The Lagrangian heuristic described herein was used to obtain the upper bound. FIG. 5 gives the resultant computations. In addition to the lower bounds and upper bounds, also calculated are the percentage gap in FIG. 4, which is defined as (UB-LB)/UB*100.

At least one of the LRⱼ subproblems was unsolvable within one hour of CPU usage time for problems 21 through 25. The percentage gap was less than 3% in 8 out of the 20 cases. However, the results are not encouraging for the remaining 12 cases, where the percentage gaps were in the range of 16% to 86%. In fact, the greedy heuristic performed better than (or as good as) the Lagrangian upper bound in 15 of the 20 test problems. In addition, the greedy heuristic was able to solve all test problems (with negligible CPU time) that the Lagrangian relaxation was unable to solve. The algorithm for exact solution was able to solve problems 21 and 22 within 8 hours of CPU time. However, a Lagrangian solution was unobtainable for these problems with the CPU usage limit for each LRⱼ problem (typically used was 30 subgradient iterations). Based on the computational experience, the conclusion was that the greedy heuristic and the algorithm for exact solution are most useful for the ISCI rotator problem.

Two extensions to the basic ISCI Rotator problem described so far are now considered. The first extension is called the ISCI Rotator problem with pre-placed balls, and the second extension is called the ISCI Rotator problem with equal time intervals. The two extensions are described in the following two sections.

### The ISCI Rotator Problem with Pre-Placed Balls (Section 7.1)

This extension represents a situation encountered while scheduling commercials for the broadcast television company. Many advertisers want specific slots for certain commercials. For example, a client might want its commercial that targets a certain demographic group to be aired on a certain show. A network typically accommodates these requests while still maintaining the overall objective of placing the commercials of an ISCI code as much evenly spaced as possible. Given that the exact identity of the desired slot is known, this situation can readily be accommodated in the herein descried modeling framework by assuming that some slots out of N possible slots contain pre-placed balls. This extension is called the ISCI Rotator problem with pre-placed balls. Stating in more formal terms, the discussions so far focused on placing N balls into N slots when all slots were empty. Now the extension provides a problem in which N slots out of which p slots have balls pre-placed in them and the remaining m slots are empty. Therefore, N=p+m. Out of the p pre-placed balls, p₁ are of color 1, P₂ are of color 2 and so on. Similarly, out of the m balls available for placement, m₁ are of color 1, m₂ are of color 2 and so on (note that total number of balls of color j is given by nⱼ=pⱼ+mⱼ). One wants to place the m available balls into m slots such that the balls of any specific color are as much evenly spaced as possible in the final arrangement of N balls. Note that the pre-placed balls are sacrosanct, i.e., neither the position nor the color of the balls in the pre-placed slots can be altered.

This extension can conceptually be accommodated in the formulation P2 by fixing the Yᵢⱼₖ variables to 1 for those slots where ball have been pre-placed. In other words, at least one ball is manually placed and P2 is used to automatically place the reminder balls. However, the implementation poses a problem. The balls of each color are ordered (by the index i) in P2. If slot k contains a pre-placed ball of color j, one needs to know the appropriate serial number (indexed by i) of the color j ball. For example, consider problem 3 in FIG. 1. Suppose there is a red ball pre-placed in slot 5. If this ball is designated to be ball number 1, any commercial MIP solver will attempt to place the other 4 red balls in slots 6 through 10. Thus, the improper choice of serial number for a pre-placed ball might even render a problem infeasible. A mathematical formulation where the balls of a color were not indexed was unobtainable. As a result one could not use GAMS (or any other commercial MIP solver) to solve the ISCI Rotator problem with pre-placed balls. The Algorithm, however, can be modified to handle the ISCI Rotator problem with pre-placed balls. Recall that S=(s₁,s₂, . . . , s_{N}) was defined to be a solution vector for the ISCI Rotator problem in Section 4. Note that the algorithm does not require S to be an empty vector to begin with. Thus, one can pre-specify the position and color of the pre-placed balls in the vector S and apply the algorithm to solve the ISCI Rotator problem with pre-placed balls.

Twenty-five test problems were constructed to test the effectiveness of the algorithm for problems with pre-placed balls. FIG. 5 describes the test problems. Note that these test problems are the same as those of FIG. 1 (ISCI problems without any pre-placement) in terms of N, J, and color details. Pre-placed balls were added to the problems tested earlier. Thus, problem 1.1 (of FIG. 5) is same as problem 1 (of FIG. 1) in terms of N, J, and color details. This means that problem 1.1 will have 8 balls out of which 5 are red and 3 are blue. In addition, 2 balls were pre-placed in problem 1.1; a blue one at slot 6 and a red one at slot 8. These arrangements are denoted as “6B, 8R” under the column “pre-placements” in FIG. 5. Problems 2.1 through 25.1 will have similar interpretations. The computational results for the ISCI Rotator problem with pre-placements are presented in FIG. 6. As before, all computations were run for a maximum of 8 hours CPU time on the same personal computer described earlier (Intel Pentium III processor at 850 MHz).

Optimal solutions were obtainable for 21 of the 25 test problems within 727 CPU-seconds of computation time. A 50-slot problem was solved to optimality. However, a 60-slot problem was not solvable to optimality within the allowable CPU usage time. It is also interesting to note that problem 21 was solvable within 8 hours of CPU time, while problem 21.1 was not solvable within that time frame. As mentioned in Section 6 that in addition to the number of slots, the structure of the problem also influences the computation time. This is suspected to be the case with problem 21.1. In this problem, only 5 balls were pre-placed (out of 50), which does not reduce the search space significantly. However, the same problem with 40 pre-placed balls (out of 50) was solvable within 8 hours of CPU time.

### The ISCI Rotator Problem with Equal Time Intervals (Section 7.2)

In this extension, the objective is to schedule a set of commercials on a set of available slots such that the commercials from the same advertisers (and with the same ISCI code) are as much evenly spaced in time as possible during a specific time period. This was found to be another criteria that the advertisers often specified to a network. Note that this problem is not the same as the basic ISCI Rotator problem. For example, the first available slot might be at time 1, while the second available slot might be at time 7, and the third available slot might be at time 8 and so on. The following quantities are defined to formulate the problem. Note that the definitions and notations above still hold.

Parameters

\overline{T}=the time horizon under consideration

τⱼ=ideal distance between any two commercials of color j=\overline{T}|nⱼ

t(k)=time location for slot k

Decision Variables

Tᵢ_{ⱼ}=time of airing of commercial i of color j

$$\begin{matrix}Problem P3 & \\ Minimize {\sum }_{i} {\sum }_{j} \vert {T}_{{i}_{j}} - {T}_{i - {1}_{j}} - {τ}_{j} \vert & ( 20 )\end{matrix}$$

Subject to:

Tᵢ₋₁_{ⱼ}≦Tᵢ_{ⱼ}−1, ∀i,j (21)

$$\begin{matrix}{\sum }_{i , k} {Y}_{{i}_{j} k} = {n}_{j} , ∀ j & ( 22 ) \\ {T}_{{i}_{j}} = {\sum }_{k} t ( k ) {Y}_{{i}_{j} k} , ∀ i , j & ( 23 ) \\ {\sum }_{i , j} {Y}_{{i}_{j} k} = 1 , ∀ k & ( 24 )\end{matrix}$$

Yᵢ_{ⱼ}ₖ binary (25)

Note that the total number of available slots, N, and the time location of each slot, t(k), is known. The formulation of P3 is similar to that of P1. One variable was redefined and an additional parameter was introduced. Thus, all heuristics of Section 5, and the optimal algorithm above can be used with minor modifications to solve the problem P3.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Exemplary embodiments of scheduling methods are described above in detail. The methods are not limited to the specific embodiments described herein, but rather, components of each method may be utilized independently and separately from other methods described herein.

While the invention has been described in terms of various specific embodiments, those skilled in the art will recognize that the invention can be practiced with modification within the spirit and scope of the claims.

What is claimed is:

1. A method for scheduling broadcast commercials, said method comprising automatically scheduling a commercial to air a plurality of times on a plurality of shows within a specified time period.

2. A method in accordance with claim 1 further comprising receiving a set number of times a commercial is to air during a specified time period and at least one specific time to air the commercial, said automatically scheduling comprises:
manually scheduling the airing of the commercial at the specified time; and
automatically scheduling the commercial to air a plurality of times on a plurality of shows within the specified time period.

3. A method in accordance with claim 1 further comprising calculating a lower bound to prune a portion of a search tree.

4. A method in accordance with claim 3 wherein said calculating comprises calculating a lower bound to prune a portion of a search tree using a Lagrangian relaxation procedure.

5. A method in accordance with claim 3 further comprising:
heuristically calculating a current best solution (B), wherein said calculating a lower bound comprises calculating a lower bound using B.

6. A method in accordance with claim 1 wherein said scheduling comprises scheduling the commercial such that the commercial is substantially evenly spaced in time within the specified period.

7. A method in accordance with claim 1 wherein said scheduling comprises minimizing
$${\sum }_{i} {\sum }_{j} \vert {Z}_{{i}_{j}} - {Z}_{i - {1}_{j}} - {q}_{j} \vert$$
Subject to:
Zᵢ₋₁_{ⱼ}≦Zᵢ_{ⱼ}−1, ∀i,j
$$\begin{matrix}{\sum }_{i , k} {Y}_{{i}_{j} k} = {n}_{j} , ∀ j \\ {Z}_{{i}_{j}} = {\sum }_{k} {kY}_{{i}_{j} k} , ∀ i , j \\ {\sum }_{i , j} {Y}_{{i}_{j} k} = 1 , ∀ k\end{matrix}$$
1≦Zᵢ_{ⱼ}≦N,
wherein j is an index on a color, j=1, 2, . . . , J,
nⱼ is a number of balls of color j,
$$N is a total number of balls = {\sum }_{j} {n}_{j} ,$$
iⱼ in a index on balls of color j, iⱼ=1, 2, . . . , nⱼ, ∀j,
k is an index on slots, k=1, 2, . . . , N,
qⱼ in an ideal distance between any two balls of color j=N/nⱼ,
Zᵢ_{ⱼ} is a slot number of ball i of color j, and
$${Y}_{{i}_{j} k} = \{ \begin{matrix}1 , & if ball i of color j is assigned to slot k \\ 0 , & otherwise\end{matrix} .$$

8. A computer programmed to schedule a commercial to air a plurality of times on a plurality of shows within a specified time period.

9. A computer in accordance with claim 8 further programmed to receive a set number of times a commercial is to air during a specified time period and at least one specific time to air the commercial;
receive a manual schedule including at least one airing of the commercial at the specified time; and
schedule the commercial to air a plurality of times on a plurality of shows within the specified time period.

10. A computer in accordance with claim 8 further programmed to calculate a lower bound to prune a portion of a search tree.

11. A computer in accordance with claim 10 further programmed to calculate a lower bound to prune a portion of a search tree using a Lagrangian relaxation procedure.

12. A computer in accordance with claim 10 further programmed to heuristically calculate a current best solution (B), wherein said calculating a lower bound comprises calculating a lower bound using B.

13. A computer in accordance with claim 8 further programmed to schedule the commercial such that the commercial is substantially evenly spaced in time within the specified period.

14. A computer in accordance with claim 8 further programmed to minimize
$${\sum }_{i} {\sum }_{j} \vert {Z}_{{i}_{j}} - {Z}_{i - {1}_{j}} - {q}_{j} \vert$$
Subject to:
Zᵢ₋₁_{ⱼ}≦Zᵢ_{ⱼ}−1,∀i,j
$${\sum }_{i , k} {Y}_{{i}_{j} k} = {n}_{j} , ∀ j$$
$${Z}_{{i}_{j}} = {\sum }_{k} k {Y}_{{i}_{j} k} , ∀ i , j$$
$${\sum }_{i , k} {Y}_{{i}_{j} k} = 1 , ∀ k$$
1≦Zᵢ_{ⱼ}≦N,
wherein j is an index on a color, j=1, 2, . . . , J,
nⱼ is a number of balls of color j,
$$N is total number of balls = {\sum }_{j} {n}_{j} ,$$
iⱼ in a index on balls of color j, iⱼ=1, 2, . . . , nⱼ, ∀j,
k is an index on slots, k=1, 2, . . . , N,
qⱼ in an ideal distance between any two balls of color j=N/nⱼ,
Zᵢ_{ⱼ} is a slot number of ball i of color j, and
$${Y}_{{i}_{j} k} = \{ \begin{matrix}1 , if ball i of color j is assigned to slot k \\ 0 , otherwise\end{matrix} .$$

15. A computer readable medium encoded with a program configured to instruct a computer to schedule a commercial to air a plurality of times on a plurality of shows within a specified time period.

16. A computer readable medium in accordance with claim 15 wherein said program further configured to instruct the computer to receive a set number of times a commercial is to air during a specified time period and at least one specific time to air the commercial;
receive a manual schedule including at least one airing of the commercial at the specified time; and
schedule the commercial to air a plurality of times on a plurality of shows within the specified time period.

17. A computer readable medium in accordance with claim 15 wherein said program further configured to instruct the computer to calculate a lower bound to prune a portion of a search tree.

18. A computer readable medium in accordance with claim 15 wherein said program further configured to instruct the computer to calculate a lower bound to prune a portion of a search tree using a Lagrangian relaxation procedure.

19. A computer readable medium in accordance with claim 17 wherein said program further configured to instruct the computer to heuristically calculate a current best solution (B), wherein said calculating a lower bound comprises calculating a lower bound using B.

20. A computer readable medium in accordance with claim 15 wherein said program further configured to instruct the computer schedule the commercial such that the commercial is substantially evenly spaced in time within the specified period.
